(19) United States
(12) Patent Application Publication
(10) Pub. No.: US 2002/0015915 A1
(43) Pub. Date: Feb. 7, 2002

(54) Azo compound containing metal and optical recording medium using the compound

(76) Inventors: Yoshiyuki Nagataki, Ibaraki-ken (JP); Yuichi Sakurai, Toride-shi (JP); Kouji Takazawa, Yokohama-shi (JP); Yoshiharu Iinuma, Yawata-shi (JP); Masatoshi Taniguchi, Kyoto-shi (JP); Noriko Ueda, Amagasaki-shi (JP)

Correspondence Address: BIRCH STEWART KOLASCH & BIRCH, PO BOX 747, FALLS CHURCH, VA, 22040-0747, US

(21) Appl. No.: 09/873,260

(22) Filed: Jun. 5, 2001

(30) Foreign Application Priority Data
Jun. 5, 2000 (JP) 2000-167711

(51) Int. Cl. G11B 7/24; C09B 45/22; C09B 44/02; C09B 44/08

(52) U.S. Cl. 430/270.16; 430/945; 534/707; 534/713; 534/613; 534/604

(57) ABSTRACT

An object of the present invention is to provide an optical recording medium that is excellent in recording and reading-out characteristics in the case of using a shortwave semiconductor laser and is good in light resistance and durability. A metal-containing azo compound comprising an azo compound represented by the following general formula [I] and at least one metal salt:

General formula [I]

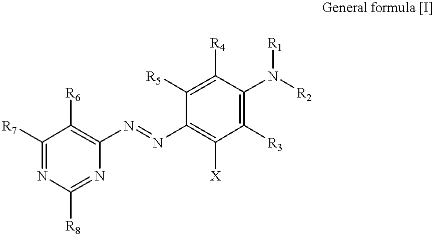

wherein X is a hydroxyl group, a carboxyl group, a sufonamide group, a carbonylamide group or an amino group, R₁ and R₂ are independently a hydrogen atom, a substituted or unsubstituted and linear or branched alkyl group, a substituted or unsubstituted and unsaturated hydrocarbon, a substituted or unsubstituted aromatic ring, or an alkoxy group, each of R₃, R₄, R₅, R₆, R₇ and R₈ is a hydrogen atom, a linear or branched alkyl group which may have one or more substituents, a linear or branched and unsaturated hydrocarbon which may have one or more substituents, a substituted or unsubstituted aromatic ring, an alkoxy group, a halogen atom or a cyano group, and a combination of R₁ and R₂ or a combination of R₆ and R₇ may form a ring through a connecting group.

### BACKGROUND OF THE INVENTION

The present invention relates to a metal-containing azo compound comprising an azo compound and at least one metal salt, and an optical recording medium that has a recording layer containing the metal-containing azo compound and permits recording/reading-out of information by means of laser beams.

Various optical recording media have been proposed which permit recording and reading-out of information by means of light. Of these, there are known optical recording media obtained by using an organic pigment material in a recording layer. An example of them is that disclosed in Japanese Patent Kokai No. 2-168446.

This optical recording medium is so-called CD-R, an optical recording medium permitting writing that has a high reflectance and gives output signals according to a CD format in reading-out of information. It is obtained by laminating a recording layer containing a pigment, a reflective layer and then a protective layer on the pre-format pattern formation surface of a transparent substrate and is characterized in that laser beams are absorbed into the recording layer to be converted to heat, by which information is recorded.

Recently, there has been a desire for an optical recording medium having a higher packing density and a method has been investigated in which a shortwave semiconductor laser having a shorter output wavelength of 600 to 700 nm is used and the diameter of beam spot is reduced to increase the packing density. Such high-density optical recording media permit recording of high-volume data such as an animation, and their standardization as DVD-R has been in progress in recent years.

However, optical recording media using in its recording layer a pigment material used in present-day CD-R are disadvantageous in that when a shortwave laser is used, they do not permit recording and reading-out because of their low reflectance. As to a pigment material used in the recording layer of DVD-R in the case of using such a shortwave laser, Japanese Patent Kokai No. 6-336086 discloses employment of a cyanine pigment, Japanese Patent Kokai No. 9-58123 discloses employment of a metal-containing azo pigment, and Japanese Patent Kokai No. 10-287819 discloses employment of a benzopyrromethene compound. The pigment materials proposed at present, however, are disadvantageous in that they cause a serious jitter and are not sufficient in light resistance.

### SUMMARY OF THE INVENTION

An object of the present invention is to provide a novel metal-containing azo compound as a pigment material which solves the above problems and is suitable for optical recording media, etc., and to provide an optical recording medium which is excellent in recording and reading-out characteristics in the case of using a shortwave semiconductor laser and is good in light resistance and durability, by using said metal-containing azo compound in a recording layer.

In order to achieve the above object, a first aspect of the present invention is characterized in that it is obtained from an azo compound represented by the following general formula [I] and at least one metal salt of, for example, Ni, Co, Zn or Cu:

General formula [I]

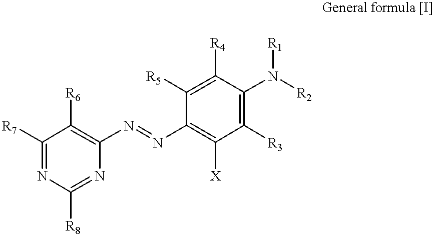

wherein X is a hydroxyl group, a carboxyl group, a sufonamide group, a carbonylamide group or an amino group, R₁ and R₂ are independently a hydrogen atom, a substituted or unsubstituted and linear or branched alkyl group, a substituted or unsubstituted and unsaturated hydrocarbon, a substituted or unsubstituted aromatic ring, or an alkoxy group, each of R₃, R₄, R₅, R₆, R₇ and R₈ is a hydrogen atom, a linear or branched alkyl group which may have one or more substituents, a linear or branched and unsaturated hydrocarbon which may have one or more substituents, a substituted or unsubstituted aromatic ring, an alkoxy group, a halogen atom or a cyano group, and a combination of R₁ and R₂ or a combination of R₆ and R₇ may form a ring through a connecting group.

In order to achieve the above object, a second aspect of the present invention is characterized in that it is obtained from an azo compound represented by the following general formula [II] and at least one metal salt of, for example, Ni, Co, Zn or Cu:

General formula [II]

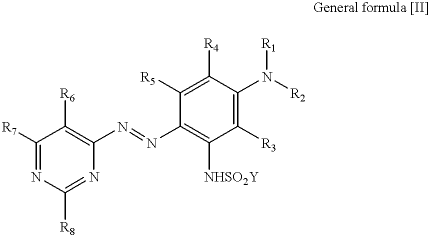

wherein Y is a substituted or unsubstituted and linear or branched alkyl group, a substituted or unsubstituted and unsaturated hydrocarbon, or a substituted or unsubstituted aromatic ring, R₁ and R₂ are independently a hydrogen atom, a substituted or unsubstituted and linear or branched alkyl group, a substituted or unsubstituted and unsaturated hydrocarbon, a substituted or unsubstituted aromatic ring, or an alkoxy group, each of R₃, R₄, R₅, R₆, R₇ and R₈ is a hydrogen atom, a linear or branched alkyl group which may have one or more substituents, a linear or branched-and unsaturated hydrocarbon which may have one or more substituents, a substituted or unsubstituted aromatic ring, an alkoxy group, a halogen atom or a cyano group, and a combination of R₁ and R₂ or a combination of R₆ and R₇ may form a ring through a connecting group.

In order to achieve the above object, a third aspect of the present invention is characterized in that it is obtained from an azo compound represented by the following general formula [III] and at least one metal salt of, for example, Ni, Co, Zn or Cu:

General formula [III]

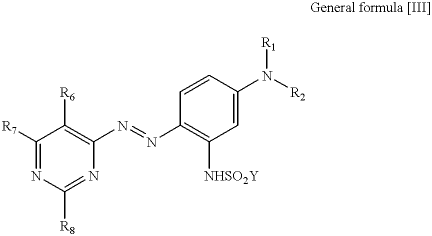

wherein Y is a substituted or unsubstituted and linear or branched alkyl group, a substituted or unsubstituted and unsaturated hydrocarbon, or a substituted or unsubstituted aromatic ring, R₁ and R₂ are independently a hydrogen atom, a substituted or unsubstituted and linear or branched alkyl group, a substituted or unsubstituted and unsaturated hydrocarbon, a substituted or unsubstituted aromatic ring, or an alkoxy group, each of R₆, R₇ and R₈ is a hydrogen atom, a linear or branched alkyl group which may have one or more substituents, a linear or branched and unsaturated hydrocarbon which may have one or more substituents, a substituted or unsubstituted aromatic ring, an alkoxy group, a halogen atom or a cyano group, and a combination of R₁ and R₂ or a combination of R₆ and R₇ may form a ring through a connecting group.

In order to achieve the above object, a fourth aspect of the present invention is characterized in that as a material for an optical recording layer, it is composed mainly of a metal-containing azo compound according to any one of the above-mentioned first to third aspects of the invention.

In order to achieve the above object, a fifth aspect of the present invention is directed to an optical recording medium comprising a transparent substrate and a recording layer formed thereon and permitting recording/reading-out of information by light beams, which is characterized in that said recording layer contains a metal-containing azo compound according to any one of the above-mentioned first to third aspects of the invention.

### BRIEF DESCRIPTION OF DRAWINGS

FIG. 1 is a table showing the compositions of various metal-containing azo compounds of the present invention.

FIG. 2 is a characteristic graph showing an absorption spectrum of a coating film containing the metal-containing azo compound produced in Example 1 of the present invention.

FIG. 3 is a characteristic graph showing an absorption spectrum of a coating film containing the metal-containing azo compound produced in Example 2 of the present invention.

FIG. 4 is a characteristic graph showing an absorption spectrum of a coating film containing the metal-containing azo compound produced in Example 3 of the present invention.

FIG. 5 is a table showing various characteristics of the optical recording media produced in Examples 14 to 26 and Comparative Examples 1 to 4 of the present invention.

### DETAILED DESCRIPTION OF THE INVENTION

The gist of the present invention is employment of an azo compound represented by the following general formula [I]:

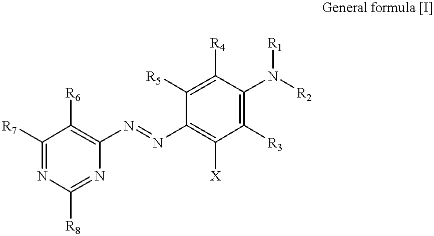

And, in the formula, R₁ and R₂ are independently a hydrogen atom, a substituted or unsubstituted and linear or branched alkyl group, a substituted or unsubstituted and unsaturated hydrocarbon, a substituted or unsubstituted aromatic ring, or an alkoxy group, each of R₃, R₄, R₅, R₆, R₇ and R₈ is a hydrogen atom, a linear or branched alkyl group which may have one or more substituents, a linear or branched and unsaturated hydrocarbon which may have one or more substituents, a substituted or unsubstituted aromatic ring, an alkoxy group, a halogen atom or a cyano group, and a combination of R₁ and R₂ or a combination of R₆ and R₇ may form a ring through a connecting group.

More specifically, R₁ and R₂ in the general formula [I] independently include, for example, hydrogen atom; linear or branched alkyl groups of 1 to 20 carbon atoms, such as methyl group, ethyl group, n-propyl group, isopropyl group, n-butyl group, tert-butyl group, sec-butyl group, n-pentyl group, n-hexyl group, n-heptyl group, n-octyl group, n-decyl group, n-dodecyl group, n-octadecyl group, etc., preferably linear or branched alkyl groups of 1 to 10 carbon atoms, more preferably linear or branched alkyl groups of 1 to 6 carbon atoms; alkoxy groups of 1 to 10 carbon atoms, such as methoxy group, ethoxy group, n-propoxy group, isopropoxy group, n-butoxy group, tert-butoxy group, sec-butoxy group, n-pentyloxy group, n-hexyloxy group, n-heptyloxy group, n-octyloxy group, n-decyloxy group, etc.; alkoxyalkoxy groups of 2 to 12 carbon atoms, such as methoxymethoxy group, ethoxymethoxy group, propoxymethoxy group, methoxyethoxy group, ethoxyethoxy group, propoxyethoxy group, methoxypropoxy group, ethoxypropoxy group, methoxybutoxy group, ethoxybutoxy group, etc.; alkoxyalkoxyalkoxy groups of 3 to 15 carbon atoms, such as methoxymethoxymethoxy group, methoxymethoxyethoxy group, methoxyethoxymethoxy group, methoxyethoxyethoxy group, ethoxymethoxymethoxy group, ethoxymethoxyethoxy group, ethoxyethoxymethoxy group, ethoxyethoxyethoxy group, etc.; allyloxy group; aryl groups of 6 to 12 carbon atoms, such as phenyl group, tolyl group, xylyl group, naphthyl group, etc.; aryloxy groups of 6 to 12 carbon atoms, such as phenoxy group, tolyloxy group, xylyloxy group, naphthyloxy group, etc.; cyano group; nitro group; hydroxy group; tetrahydrofuryl group; alkylsulfonylamino groups of 1 to 6 carbon atoms, such as methylsulfonylamino group, ethylsulfonylamino group, n-propylsulfonylamino group, isopropylsulfonylamino group, n-butylsulfonylamino group, tert-butylsulfonylamino group, sec-butyl-sulfonylamino group, n-pentylsulfonyl group amino, n-hexylsulfonylamino group, etc.; halogen groups such as fluorine atom, chlorine atom, bromine atom, etc.; alkoxycarbonyl groups of 2 to 7 carbon atoms, such as methoxycarbonyl group, ethoxycarbonyl group, n--propoxy-carbonyl group, isopropoxycarbonyl group, n-butoxy-carbonyl group, tert-butoxycarbonyl group, sec-butoxycarbonyl group, n-pentyloxycarbonyl group, n-hexyloxycarbonyl group, etc.; alkylcarbonyloxy groups of 2 to 7 carbon atoms, such as methylcarbonyloxy group, ethylcarbonyloxy group, n-propylcarbonyloxy group, isopropylcarbonyloxy group, n-butylcarbonyloxy group, tert-butylcarbonyloxy group, sec-butyl--carbonyloxy group, n-pentylcarbonyloxy group; n-hexylcarbonyloxy group, etc.; and alkoxycarbonyloxy groups of 2 to 7 carbon atoms, such as methoxy-carbonyloxy group, ethoxycarbonyloxy group, n-propoxy-carbonyloxy group, isopropoxycarbonyloxy group, n-butoxycarbonyloxy group, tert-butoxycarbonyloxy group, sec-butoxycarbonyloxy group, n-pentyloxycarbonyloxy group; n-hexyloxycarbonyloxy group, etc.

Each of R₃ through R₈ in the formula includes, for example, hydrogen atom, linear or branched alkyl groups of 1 to 6 carbon atoms, such as methyl group, ethyl group, n-propyl group, isopropyl group, n-butyl group, sec-butyl group, tert-butyl group, n-pentyl group, n-hexyl group, etc.; cyclic alkyl groups of 3 to 6 carbon atoms, such as cyclopropyl group, cyclobutyl group, cyclopentyl group, cyclohexyl group, etc., alkoxy groups of 1 to 6 carbon atoms, such as methoxy group, ethoxy group, n-propoxy group, isopropoxy group, n-butoxy group, tert-butoxy group, sec-butoxy group, n-pentyloxy group, n-hexyloxy group, etc.; alkylcarbonyl groups of 1 to 6 carbon atoms, such as acetyl group, propionyl group, butyryl group, isobutyryl group, valeryl group, isovaleryl group, pivaloyl group, hexanoyl group, heptanoyl group, etc.; linear or branched alkenyl groups of 2 to 6 carbon atoms, such as vinyl group, propenyl group, butenyl group, pentenyl group, hexenyl group, etc.; cyclic alkenyl groups of 3 to 6 carbon atoms, such as cyclopentenyl group, cyclohexenyl group, etc.; halogen atoms such as fluorine atom, chlorine atom, bromine atom, etc.; formyl group; hydroxyl group; carboxyl group; hydroxy-alkyl groups of 1 to 6 carbon atoms, such as hydroxy-methyl group, hydroxyethyl group, etc.; alkoxycarbonyl groups of 2 to 7 carbon atoms, such as methoxycarbonyl group, ethoxycarbonyl group, n-propoxycarbonyl group, isopropoxycarbonyl group, n-butoxycarbonyl group, tert-butoxycarbonyl group, sec-butoxycarbonyl group, n-pentyloxycarbonyl group, n-hexyloxycarbonyl group, etc.; nitro group; cyano group; amino group; alkylamino groups of 1 to 10 carbon atoms, such as methylamino group, ethylamino group, n-propylamino group, n-butylamino group, dimethylamino group, diethylamino group, di-n-propylamino group, di-n-butylamino group, etc.; alkoxycarbonylalkyl groups of 3 to 7 carbon atoms, such as methoxycarbonylmethyl group, ethoxy-carbonylmethyl group, n-propoxycarbonylmethyl group, isopropoxycarbonylethyl group, etc.; alkylthio groups of 1 to 6 carbon atoms, such as methylthio group, ethylthio group, n-propylthio group, tert-butylthio group, sec-butylthio group, n-pentylthio group, n-hexylthio group, etc.; alkylsulfonyl groups of 1 to 6 carbon atoms, such as methylsulfonyl group, ethyl-sulfonyl group, n-propylsulfonyl group, isopropyl-sulfonyl group, n-butylsulfonyl group, tert-butyl-sulfonyl group, sec-butylsulfonyl group, n-pentyl-sulfonyl group, n-hexylsulfonyl group, etc.; aryl groups of 6 to 16 carbon atoms which may have one or more substituents; and arylcarbonyl groups of 7 to 17 carbon atoms which may have one or more substituents.

X in the formula includes hydroxyl group, carboxyl group, sulfonamide groups, carbonylamide group, amino group, etc. The sulfonamide groups are especially preferable as X.

The sulfonamide groups are represented by —NHSO₂Y wherein Y is a substituted or unsubstituted and linear or branched alkyl group, a substituted or unsubstituted and unsaturated hydrocarbon, or a substituted or unsubstituted aromatic ring, and is preferably a substituted and linear or branched alkyl group of 1 to 6 carbon atoms having one or more fluorine atoms as the substituent(s).

Specific examples of such an alkyl group are substituted alkyl groups having as the substituent a perfluoroalkyl group of 1 to 6 carbon atoms, such as trifluoromethyl group, pentafluoroethyl group, heptafluoropropyl group or the like, or a perfluoroalkyl group of 2 to 6 carbon atoms in total, such as 2,2,2-trifluoroethyl group, 3,3,3-trifluoropropyl group, 2,2,3,3,3-pentafluoropropyl group or the like. —CF₂CF₃H, —CH₂CF₃ and —CF₃ are especially preferable.

Of such azo compounds, those represented by the following general formula [III] are more preferable:

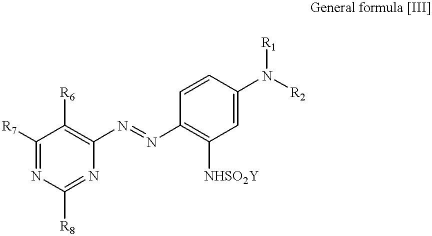

wherein Y is a substituted or unsubstituted and linear or branched alkyl group, R₁ and R₂ are independently a hydrogen atom, a substituted or unsubstituted alkyl group, a substituted or unsubstituted and unsaturated hydrocarbon, or a substituted or unsubstituted aromatic ring, each of R₆, R₇ and R₈ is a hydrogen atom, a linear or branched alkyl group which may have one or more substituents, a linear or branched and unsaturated hydrocarbon which may have one or more substituents, a substituted or unsubstituted aromatic ring, a halogen atom or a cyano group, and a combination of R₁ and R₂ or a combination of R₆ and R₇ may form a ring through a connecting group.

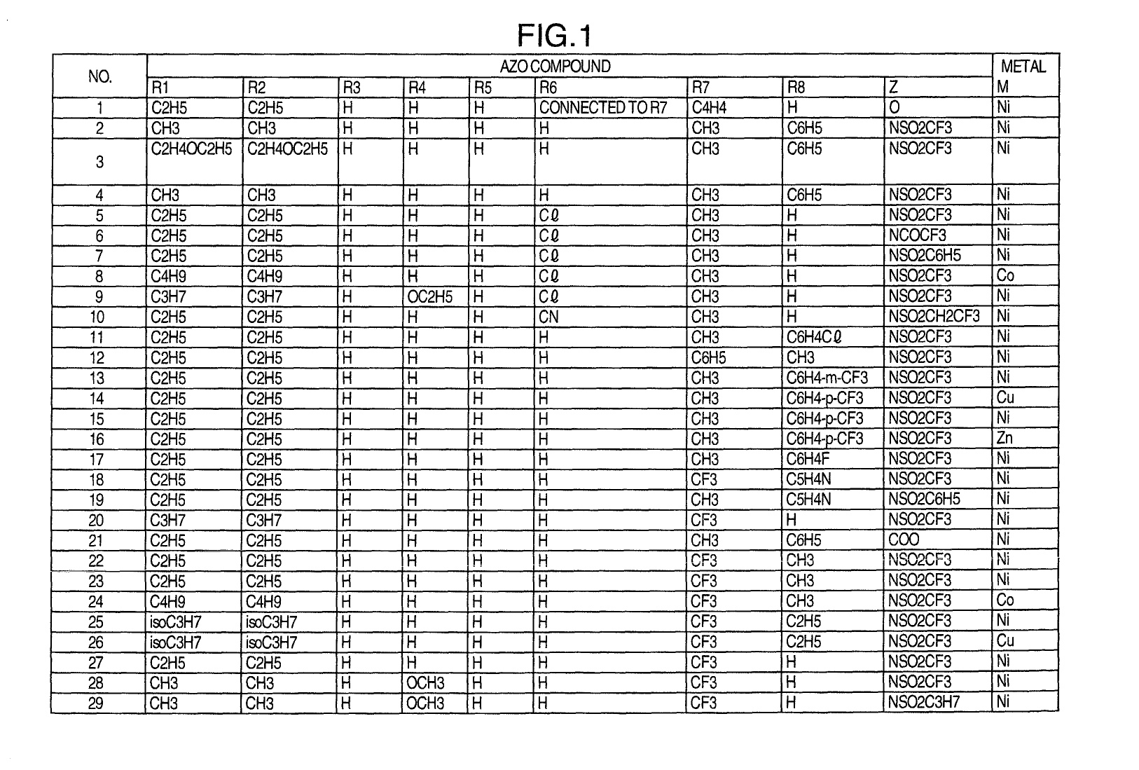

As the metal-containing azo compound comprising the azo compound and at least one metal, those listed in FIG. 1 are exemplified. This figure shows the R₁, R₂, R₃, R₄, R₅, R₆, R₇, R₈, X and metal of the azo compound represented by the following general formula [IV] and constituting the metal-containing azo compound, and shows examples of the structure:

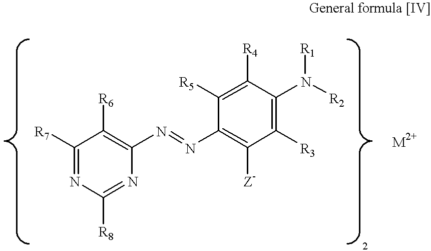

As the metal salt used for producing a complex with the azo compound in the present invention, various metal salts capable of forming the complex can be used, and salts of Ni, Co, Zn or Cu are preferable. Ni salts are especially preferable from the viewpoint of solubility in various solvents, light resistance and durability.

The metal-containing azo compound of the present invention is obtained by oxidizing a hydrazino compound of the following general formula [V] by a well-known method, reacting the oxidation product with a compound of the general formula [VI] to obtain an azo compound, and adding a methanolic or aqueous solution of a metal compound to the azo compound in an organic solvent such as methanol, tetrahydrofuran, acetone, dioxane or the like:

General formula [V]

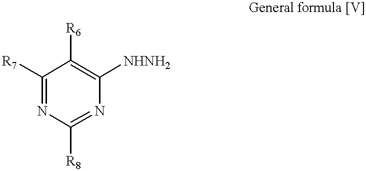

wherein R₆, R₇ and R₈ are as defined in the general formula [I],

General formula [VI]

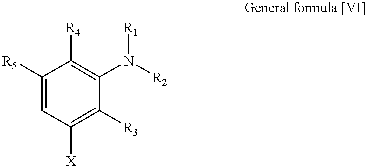

wherein X, R₁, R₂, R₃, R₄ and R₅ are as defined in the general formula [I].

Although a process for producing the hydrazino compound of the general formula [V] is not particularly limited, the hydrazino compound can be synthesized, for example, by the following process. That is, in the process, a 4-pyrimidinol derivative synthesized by the condensation of a well-known amidino compound with a well-known β-keto-ester compound is treated with a halogenating agent such as phosphorus oxychloride to produce a 4-halogenopyrimidine derivative, which is reacted with hydrazine.

The optical recording medium for shortwave recording of the present invention is obtained by forming a recording layer containing the above-mentioned metal-containing azo compound, on a transparent substrate. The optical recording medium is explained below in detail.

The substrate is preferably one that is transparent to laser beams used, and glass and various plastics are used as the substrate. The plastics include acrylic resins, methacrylic resins, polycarbonate resins, vinyl chloride resins, vinyl acetate resins, polyester resins, polyethylene resins, polypropylene resins, polyimide resins, polystyrene resins, epoxy resins, etc. Injection-molded polycarbonate resin substrates are especially preferable from the viewpoint of high productivity, cost and moisture resistance.

The shape of the substrate may be a disc shape, a card shape or the like. The substrate surface has grooves and/or pits, which indicate recording positions. Pits capable of indicating information may be formed on the substrate surface. Although such grooves and pits are preferably given in the molding of the substrate, they can be given by forming a layer of ultraviolet-curable resin on the substrate. The width of the groove is preferably 0.2 to 0.4 μm, and the depth of the groove is preferably 0.1 to 0.2 μm.

In the optical recording medium of the present invention, the recording layer contains the metal-containing azo compound, and a primer layer may be formed on the substrate if necessary.

As to a method for forming the recording layer, the recording layer can be formed by a conventional method for forming a thin film, such as a vacuum deposition method, sputtering method, doctor blade method, cast method, spin coating method, dipping method or the like. The spin coating method is preferable from the viewpoint of mass production and cost.

If necessary, a binder may be used. As the binder, known ones such as poly(vinyl alcohol)s, poly(vinylpyrrolidone)s, ketone resins, nitrocellulose, cellulose acetate, poly(vinyl butyral)s, polycarbonates, etc. are used. In the formation by the spin coating method, the number of revolution is preferably 500 to 5000 rpm, and a treatment such as heating or exposure to solvent vapor may be carried out after spin coating when occasion demands.

For stabilizing the recording layer and improving the light resistance of the recording layer, the recording layer may contain a transition, metal-containing azo compound (e.g. acetylacetonate chelates, bisphenyldithiols, salicylaldehyde oximes and bisdithio-α-diketones) as a singlet oxygen quencher. In addition, other pigments may be co-used if necessary. As the other pigments, there may be used either different compounds in the same family or compounds in a different family, such as triarylmethane pigments, azo pigments, cyanine pigments, squalirium pigments, metal-containing indoaniline pigments, phthalocyanine pigments, etc.

A solvent for coating used in the case of forming the recording layer by a coating method such as the doctor blade method, cast method, spin coating method or dipping method, in particular, by the spin coating method is not particularly limited so long as it does not attack the substrate. The solvent includes, for example, ketone alcohol solvents such as diacetone alcohol, 3-hydroxy-3-methyl-2-butanone, etc.; Cellosolve solvents such as methyl Cellosolve, ethyl Cellosolve, etc.; hydrocarbon solvents such as n-hexane, n-heptane, etc.; hydrocarbon solvents such as cyclohexane, methylcyclohexane, ethylcyclohexane, dimethylcyclohexane, n-butylcyclohexane, t-butylcyclohexane, cyclooctane, etc.; ether solvents such as diisopropyl ether, dibutyl ether, etc.; perfluoroalkyl alcohol solvents such as tetrafluoropropanol, octafluoropentanol, hexafluorobutanol, etc.; and hydroxy ester solvents such as methyl lactate, ethyl lactate, methyl isobutyrate, etc.

In the present invention, a reflective layer is formed on the recording layer directly or through another layer. Metals such as gold, silver, aluminum, copper, platinum and the like or alloys containing these metals are used as the reflective layer. Gold, silver, aluminum or alloys composed mainly of these metals are preferable from the viewpoint of reflectance and durability. The thickness of the reflective layer is 40 to 200 nm, preferably 60 to 150 nm. A method for forming this layer includes, for example, a sputtering method, vacuum deposition method and ion plating method.

A light interference layer may be formed between the recording layer and the reflective layer in order to improve characteristics such as reflectance and modulation factor. As a material for forming the light interference layer, inorganic dielectrics and polymers are exemplified.

In the present invention, since the numerical aperture of an object lens is large, the thickness of the substrate is preferably about 0.4 to about 0.8 mm for reducing the aberration. In this case, two substrates may be stuck together with an adhesive in order to improve the strength and mechanical properties of the recording medium. When stuck together, the substrates may be stuck together either after or without forming a protective layer on the reflective layer.

As the protective layer, any layer may be formed so long as it can protect the recording layer and the reflective layer, and it is formed of, for example, an ultraviolet-curable resin or a silicone resin. As the adhesive used for the sticking, ultraviolet-curable resins, hot-melt adhesives, etc. are used. In this case, a recording layer may be formed on each of the substrates to be stuck together, or one of the substrates may be a dummy substrate having no recording layer. If necessary, a printing layer or a print receptive layer may be formed on the substrate surface on the dummy substrate side.

Recording on the optical recording medium is conducted by irradiating the recording layer formed on each or one side of the recording medium, with laser beams. In the portion irradiated with laser beams, the recording layer undergoes a thermal deformation involving decomposition, heat generation, melting, etc., owing to the absorption of laser beam energy. Information recorded is read out by reading the difference between the reflectance in the portion where the thermal deformation has been caused and that in the portion where no thermal deformation has been caused, by laser beams.

Various lasers can be used and those having an output wavelength of 600 to 700 nm are preferable from the viewpoint of the absorbance of the recording layer. Semiconductor lasers are suitable from the viewpoint of lightweight properties, ease of handling, compactness, cost, etc.

### DESCRIPTION OF PREFERRED EMBODIMENT

This invention is concretely explained below with examples but the examples do not limit the present invention within the scope of the gist of the invention.

### EXAMPLE 1

In 5 ml of N,N-dimethylformamide were dissolved 0.71 g of 4-hydrazino-2-phenylquinazoline of the structural formula [7] shown below and 0.66 g of 3-(N,N-dibutylamino)phenol of the structural formula [8] shown below, followed by adding thereto 2 ml of acetic acid and 0.061 g of iodine, and 4.8 g of a 5% aqueous hydrogen peroxide solution was added dropwise thereto with stirring over a period of 90 minutes. Then, the resulting mixture was stirred at room temperature for 1 hour, and the pigment component precipitated was collected by filtration and dried. The dried pigment component was washed with methanol to obtain 1.0 g of crystals of an azo compound of the structural formula [9] shown below.

Structural formula [7]

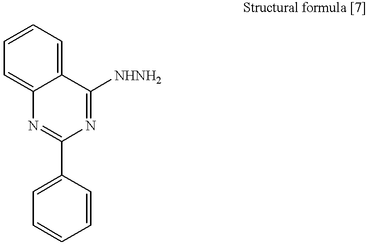

Structural formula [8]

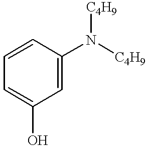

Structural formula [9]

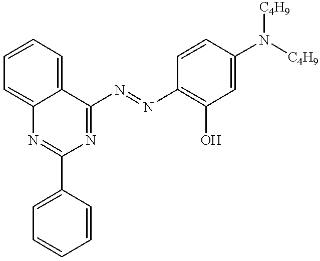

To 10 ml of methanol was added 1.0 g of the thus obtained azo compound of the structural formula [9], followed by adding thereto 0.27 g of nickel acetate tetrahydrate with stirring, and the resulting mixture was stirred with heating at the reflux temperature of the solvent. The heating was stopped and the reaction mixture was allowed to cool and then was filtered, after which the crystals were recrystallized from methanol to obtain 0.62 g of a metal-containing azo compound of the following structural formula [10] as greenish-brown crystals. A molecular ion peak M⁺=964 was confirmed by MS analysis.

Structural formula [10]

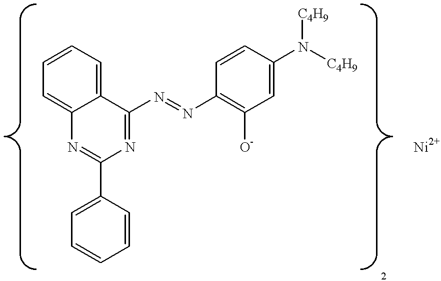

A 1 wt % solution of this compound in tetrafluoropropanol was prepared and a thin film was formed of a thin film on a flat polycarbonate disc by a spin coating method.

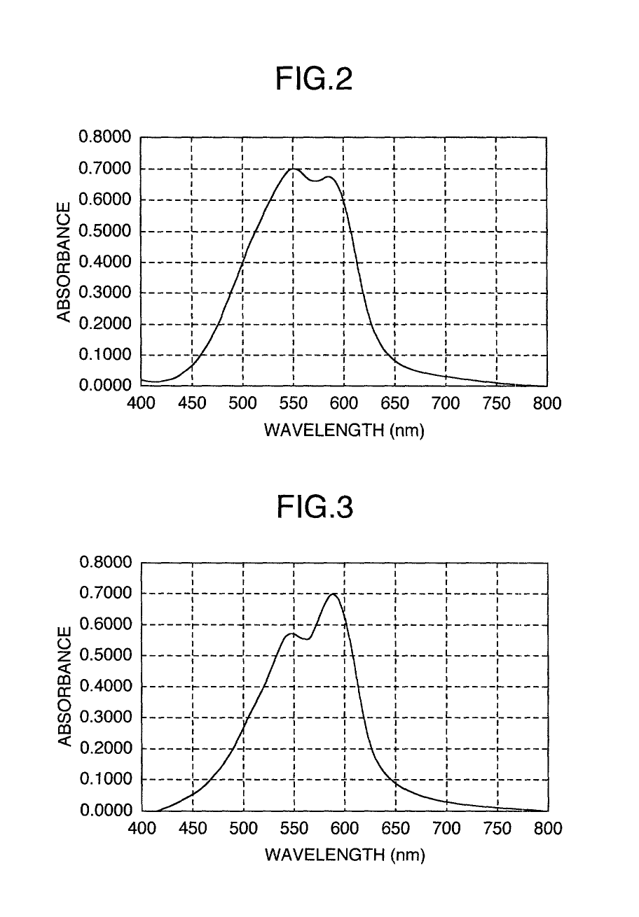

FIG. 2 shows the result of measuring an absorption spectrum of the thin film by a transmission method. As is clear from this figure, λmax of the thin film was 551 nm.

### EXAMPLE 2

In 15 ml of methanol were dissolved 2.0 g of 4-hydrazino-6-methyl-2-phenylpyrimidine of the structural formula [11] shown below and 2.9 g of 3-trifluoromethylsulfonylamino-N,N-dimethylaniline of the structural formula [12] shown below, followed by adding thereto 5 ml of acetic acid and 0.05 g of iodine, and 2.5 g of a 30% aqueous hydrogen peroxide solution was added dropwise thereto with stirring over a period of 1 hour. Then, the resulting mixture was stirred at room temperature for 1 hour, and the pigment component precipitated was collected by filtration and dried. The dried pigment component was washed with methanol to obtain 1.9 g of crystals of an azo compound of the structural formula [13] shown below.

Structural formula [11]

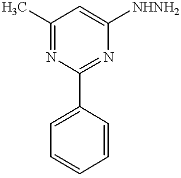

Structural formula [12]

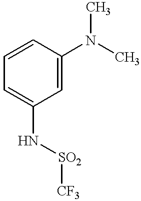

Structural formula [13]

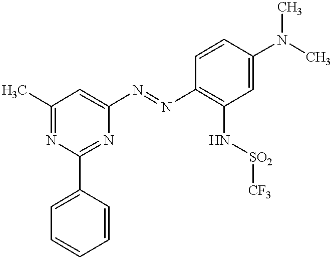

To 8 ml of methanol was added 1.3 g of the thus obtained azo compound of the structural formula [13], followed by adding thereto 0.36 g of nickel acetate tetrahydrate with stirring, and the resulting mixture was stirred with heating at the reflux temperature of the solvent. The heating was stopped and the reaction mixture was allowed to cool and then was filtered, after which the crystals were washed with acetone to obtain 1.2 g of greenish-brown crystals of a metal-containing azo compound (2) of the structural formula [14] shown below. A molecular ion peak M⁺=986 was confirmed by MS analysis.

FIG. 3 shows the result of measuring an absorption spectrum of a thin film of this compound in the same manner as in Example 1. As is clear from this figure, λmax of the thin film was 589 nm.

Structural formula [14]

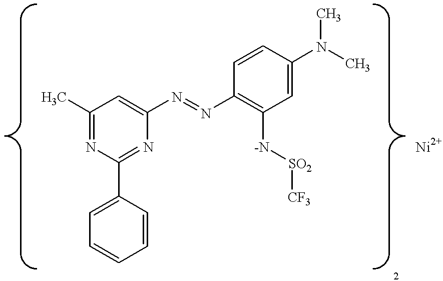

### EXAMPLE 3

In 60 ml of methanol were dissolved 7.5 g of 5-chloro-4-hydrazino-6-methylpyrimidine of the structural formula [15] shown below and 13.8 g of 3-trifluoromethylsulfonylamino-N, N-diethylaniline of the structural formula [16] shown below, followed by adding thereto 15 ml of acetic acid and 0.24 g of iodine, and 11 g of a 30% aqueous hydrogen peroxide solution was added dropwise thereto with stirring over a period of 2 hours. Then, the resulting mixture was stirred at room temperature for 3 hours, after which a small volume of water was added thereto and the pigment component precipitated was collected by filtration and dried. The dried pigment component was washed with methanol and then acetone to obtain 0.40 g of crystals of an azo compound of the structural formula [17] shown below.

Structural formula [15]

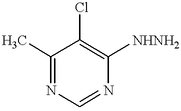

Structural formula [16]

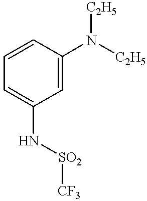

Structural formula [17]

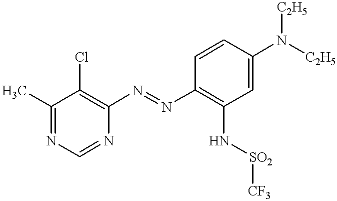

To 2 ml of methanol was added 0.29 g of the thus obtained azo compound of the structural formula [17], followed by adding thereto 0.080 g of nickel acetate tetrahydrate with stirring, and the resulting mixture was stirred with heating at reflux temperature for 2.5 hours. The heating was stopped and the reaction mixture was allowed to cool and then was filtered, after which the crystals were washed with methanol to obtain 0.22 g of greenish-brown crystals of a metal-containing azo compound of the structural formula [18] shown below. A molecular ion peak M⁺=958 was confirmed by MS analysis.

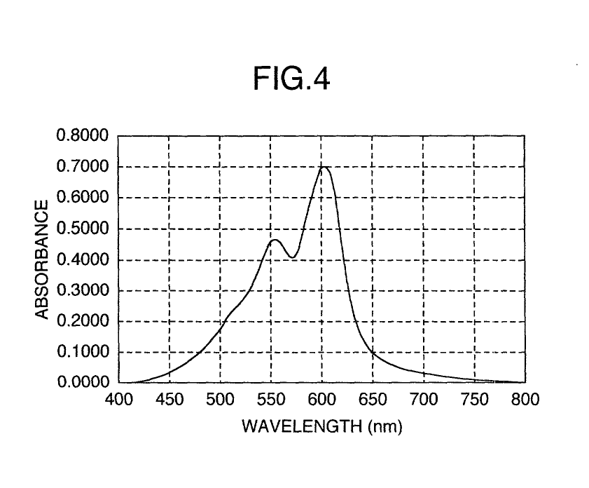

FIG. 4 shows the result of measuring an absorption spectrum of a thin film of this compound in the same manner as in Example 1. As is clear from this figure, λmax of the thin film was 603 nm.

Structural formula [18]

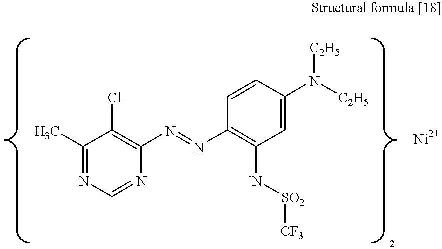

In the following Examples 4 to 13, metal-containing azo compounds were produced in a manner similar to those in the above Examples 1 to 3, and the structural formulas of these compounds and λmax of coating films of the compounds are shown.

### EXAMPLE 4

The metal-containing azo compound produced had the following structural formula [19] and λmax of a coating film containing this compound was 604 nm:

Structural formula [19]

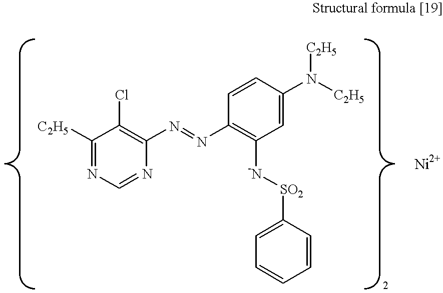

### EXAMPLE 5

The metal-containing azo compound produced had the following structural formula [20] and λmax of a coating film containing this compound was 602 nm:

Structural formula [20]

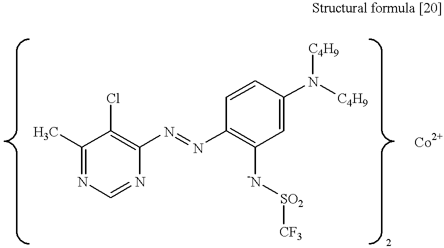

### EXAMPLE 6

The metal-containing azo compound produced had the following structural formula [21] and λmax of a coating film containing this compound was 600 nm:

Structural formula [21]

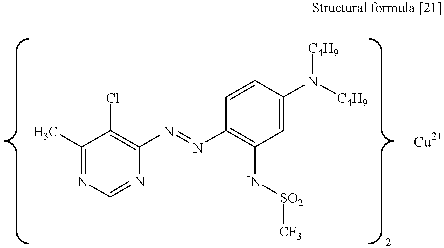

### EXAMPLE 7

The metal-containing azo compound produced had the following structural formula [22] and λmax of a coating film containing this compound was 592 nm:

Structural formula [22]

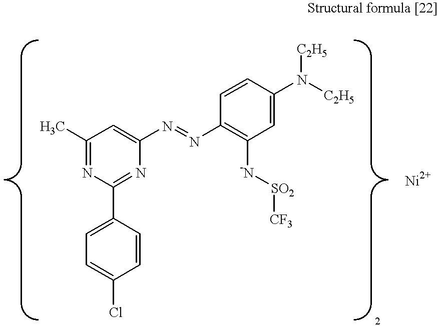

### EXAMPLE 8

The metal-containing azo compound produced had the following structural formula [23] and λmax of a coating film containing this compound was 601 nm:

Structural formula [23]

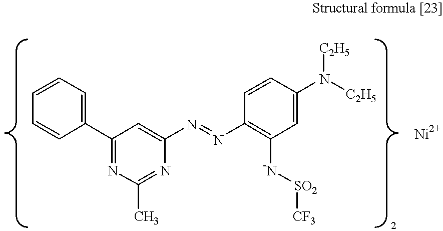

### EXAMPLE 9

The metal-containing azo compound produced had the following structural formula [24] and λmax of a coating film containing this compound was 600 nm:

Structural formula [24]

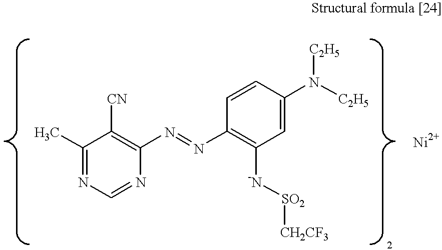

### EXAMPLE 10

The metal-containing azo compound produced had the following structural formula [25] and λmax of a coating film containing this compound was 591 nm:

Structural formula [25]

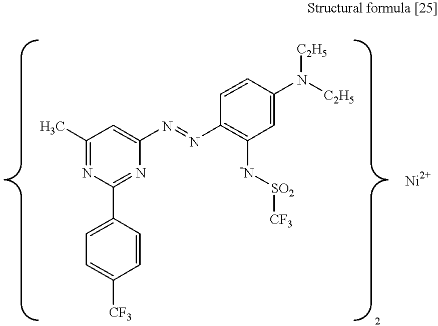

### EXAMPLE 11

The metal-containing azo compound produced had the following structural formula [26] and λmax of a coating film containing this compound was 590 nm:

Structural formula [26]

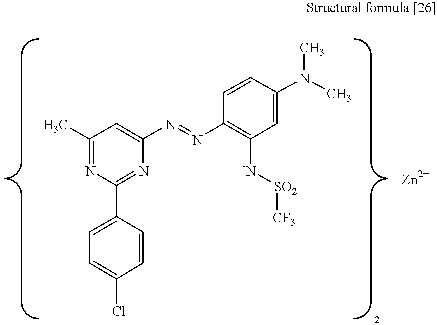

### EXAMPLE 12

The metal-containing azo compound produced had the following structural formula [27] and λmax of a coating film containing this compound was 593 nm:

Structural formula [27]

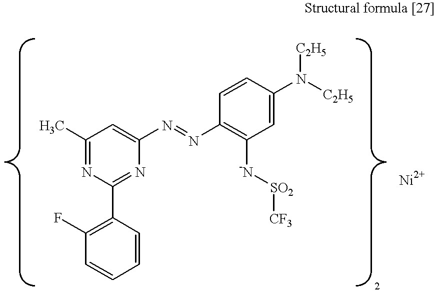

### EXAMPLE 13

The metal-containing azo compound produced had the following structural formula [28] and λmax of a coating film containing this compound was 591 nm:

Structural formula [28]

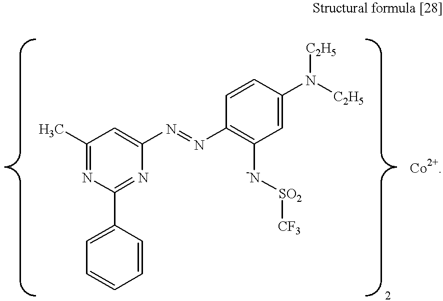

### EXAMPLE 14

In 40 g of octafluoropentanol was dissolved 0.5 g of the metal-containing azo compound obtained in Example 1. The resulting solution was subjected to ultrasonic dispersion at 40° C. for 30 minutes and then filtered through a filter of 0.2 μm. The filtrate was spin-coated on a polycarbonate substrate of 0.6 mm thick having pre-groups with a track pitch of 0.8 μm, a groove wide of 0.33 μm and a groove depth of 160 nm, at a number of revolution of 1000 rpm to form a recording layer of about 170 nm thick.

Then, this substrate was dried in an oven at 80° C. for 30 minutes, after which an Au film of 100 nm thick was formed as a reflective layer on the recording layer by a sputtering method. In addition, an ultraviolet-curable resin was spin-coated on the reflective layer to a thickness of 5 μm and irradiated with ultraviolet light to be cured, whereby substrate having the recording layer formed thereon was obtained. Furthermore, this substrate was stuck on a dummy substrate obtained in the same manner as above except for forming no recording layer, with a delayed-action ultraviolet-curable adhesive to obtain an optical recording medium.

Using a drive for recording (DDU-1000, mfd. by PULSTEC Industrial Co., Ltd.) mounted with a semiconductor laser of 636 nm (NA=0.6), 8-16 signals for DVD were input to the optical recording medium at a linear velocity of 3.5 m/s and a recording power of 9 mW to be recorded thereon. In the case of this optical recoding medium, signals read out were measured by using a drive for reading-out (DDU-1000, mfd. by PULSTEC Industrial Co., Ltd.) mounted with a semiconductor laser of 652 nm (NA=0.6), to obtain the following satisfactory reading-out characteristics: reflectance 55%, modulation factor 63% and jitter 8.7%.

### EXAMPLE 15

In 40 g of tetrafluoropropanol was dissolved 0.5 g of the metal-containing azo compound obtained in Example 2. The resulting solution was subjected to ultrasonic dispersion at 40° C. for 30 minutes and then filtered through a filter of 0.2 μm. The filtrate was spin-coated on a polycarbonate substrate of 0.6 mm thick having pre-grooves with a track pitch of 0.8 μm, a groove wide of 0.33 μm and a groove depth of 170 nm, at a number of revolution of 1500 rpm to form a recording layer of about 180 nm thick.

Then, this substrate was dried in an oven at 80° C. for 30 minutes, after which an Au film of 100 nm thick was formed as a reflective layer on the recording layer by a sputtering method. In addition, an ultraviolet-curable resin was spin-coated on the reflective layer to a thickness of 6 μm and irradiated with ultraviolet light to be cured, whereby substrate having the recording layer formed thereon was obtained. Furthermore, this substrate was stuck on another substrate having a recording layer formed thereon which had been produced in exactly the same manner as above, with a delayed-action ultraviolet-curable adhesive to obtain an optical recording medium.

In the same manner as in Example 14, 8-16 signals for DVD were input at a recording power of 9 mW to be recorded. In the case of this optical recording medium, signals read out were measured in the same manner as in Example 14 to obtain the following satisfactory reading-out characteristics: reflectance 60%, modulation factor 65% and jitter 7.6%.

### EXAMPLE 16

A substrate of about 170 nm thick having a recording layer formed thereon was obtained in the same manner as in Example 14 except for using the metal-containing azo compound obtained in Example 3. In addition, this substrate was stuck on a dummy substrate having no recording layer formed thereon, with a delayed-action ultraviolet-curable adhesive to obtain an optical recording medium.

In the same manner as in Example 14, 8-16 signals for DVD were input to this optical recording medium at a recording power of 9 mW to be recorded thereon. In the case of this optical recording medium, signals read out were measured in the same manner as in Example 14 to obtain the following satisfactory reading-out characteristics: reflectance 61%, modulation factor 62% and jitter 7.6%.

In Examples 17 to 26, optical recording media were produced in the same manner as in Example 14 except for using the metal-containing azo compounds of Examples 4 to 13, respectively, and their recording and reading-out characteristics were evaluated.

### COMPARATIVE EXAMPLE 1

An optical recording medium was obtained in the same manner as in Example 14 except for using a cyanine pigment of the following structural formula (29) in place of the metal-containing azo compound obtained in Example 1:

Structural formula [29]

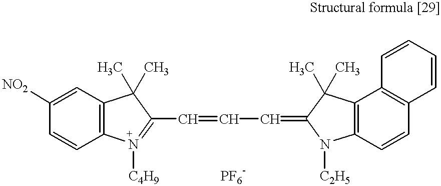

### COMPARATIVE EXAMPLE 2

An optical recording medium was obtained in the same manner as in Example 14 except for using a metal-containing azo compound of the following structural formula (30) in place of the metal-containing azo compound obtained in Example 1:

Structural formula [30]

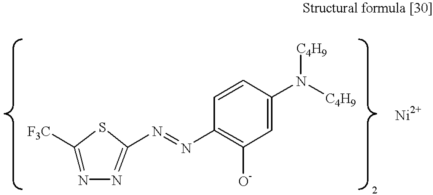

### COMPARATIVE EXAMPLE 3

An optical recording medium was obtained in the same manner as in Example 14 except for using a metal-containing azo compound of the following structural formula (31) in place of the metal-containing azo compound obtained in Example 1:

Structural formula [31]

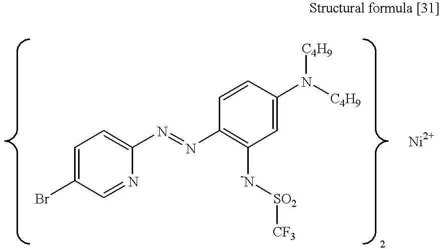

### COMPARATIVE EXAMPLE 4

An optical recording medium was obtained in the same manner as in Example 15 except for using a metal-containing azo compound of the following structural formula (32) in place of the metal-containing azo compound obtained in Example 2:

Structural formula [32]

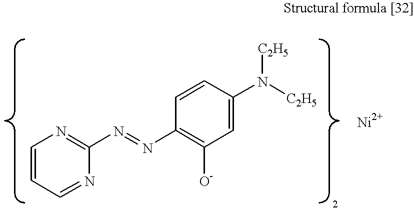

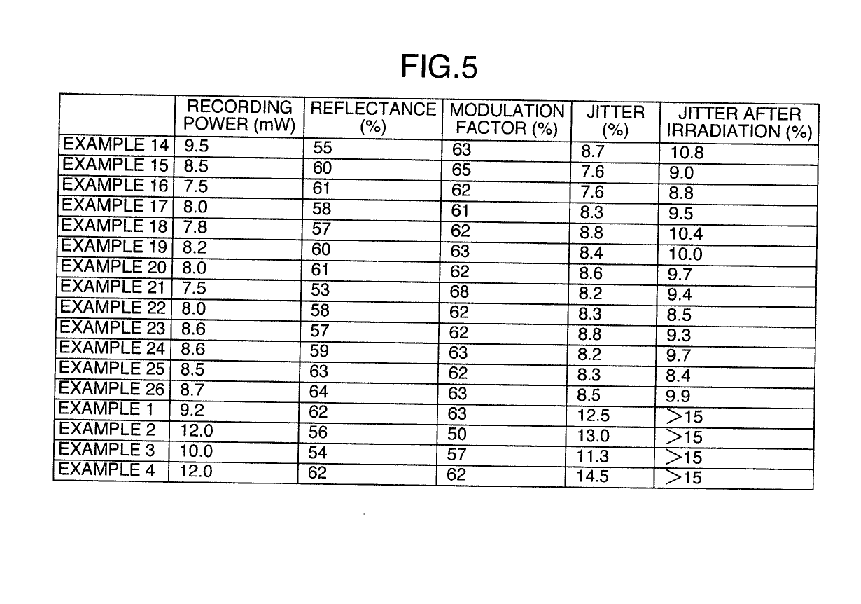

In FIG. 5, for the optical recording media produced in the above Examples 14 to 26 and Comparative Examples 1 to 4, there are shown recording power, reflectance, modulation factor, jitter, and the aggravation of jitter after irradiation of the recording layer of each optical recording medium with light having an illuminance of 70,000 lux, from a xenon lamp.

Although examples of employment of the metal-containing azo compounds of the present invention in optical recording media are described in the above Examples, the metal-containing azo compounds of the present invention are very useful compounds which can be used for purposes other than the purpose of use in optical recording media, such as coloring of various materials (e.g. plastics and paper), dyeing of various fibers, coloring of optical filters, etc.

As described above, all the metal-containing azo compounds of the present invention have an end of absorption wavelength region in a region of 600 to 700 nm and are very useful in recording layer materials for optical recording media, various optical filters, coloring agents for plastics, etc.

Furthermore, when the metal-containing azo compound of the present invention is used as a recording material, an optical recording medium can be provided which is excellent in recording and reading-out characteristics in the case of using a shortwave semiconductor laser (600 to 700n) and is good in light resistance and durability.

What is claimed is:

1. A metal-containing azo compound comprising an azo compound represented by the following general formula [I] and at least one metal salt:
General formula [I] 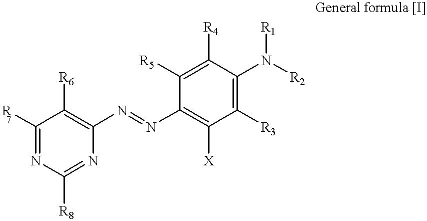
wherein X is a hydroxyl group, a carboxyl group, a sufonamide group, a carbonylamide group or an amino group, R₁ and R₂ are independently a hydrogen atom, a substituted or unsubstituted and linear or branched alkyl group, a substituted or unsubstituted and unsaturated hydrocarbon, a substituted or unsubstituted aromatic ring, or an alkoxy group, each of R₃, R₄, R₅, R₆, R₇ and R₈ is a hydrogen atom, a linear or branched alkyl group which may have one or more substituents, a linear or branched and unsaturated hydrocarbon which may have one or more substituents, a substituted or unsubstituted aromatic ring, an alkoxy group, a halogen atom or a cyano group, and a combination of R₁ and R₂ or a combination of R₆ and R₇ may form a ring through a connecting group.

2. A metal-containing azo compound comprising an azo compound represented by the following general formula [II] and at least one metal salt:
General formula [II] 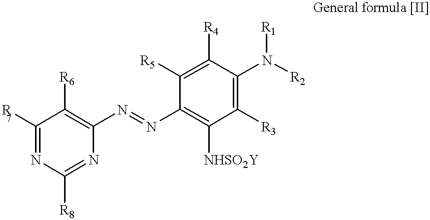
wherein Y is a substituted or unsubstituted and linear or branched alkyl group, a substituted or unsubstituted and unsaturated hydrocarbon, or a substituted or unsubstituted aromatic ring, R₁ and R₂ are independently a hydrogen atom, a substituted or unsubstituted and linear or branched alkyl group, a substituted or unsubstituted and unsaturated hydrocarbon, a substituted or unsubstituted aromatic ring, or an alkoxy group, each of R₃, R₄, R₅, R₆, R₇ and R₈ is a hydrogen atom, a linear or branched alkyl group which may have one or more substituents, a linear or branched and unsaturated hydrocarbon which may have one or more substituents, a substituted or unsubstituted aromatic ring, an alkoxy group, a halogen atom or a cyano group, and a combination of R₁ and R₂ or a combination of R₆ and R₇ may form a ring through a connecting group.

3. A metal-containing azo compound comprising an azo compound represented by the following general formula [III] and at least one metal salt:
General formula [III] 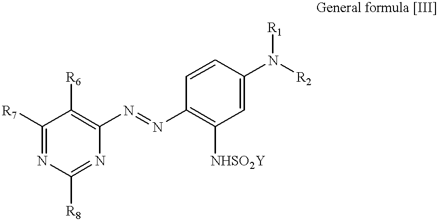
wherein Y is a substituted or unsubstituted and linear or branched alkyl group, a substituted or unsubstituted and unsaturated hydrocarbon, or a substituted or unsubstituted aromatic ring, R₁ and R₂ are independently a hydrogen atom, a substituted or unsubstituted and linear or branched alkyl group, a substituted or unsubstituted and unsaturated hydrocarbon, a substituted or unsubstituted aromatic ring, or an alkoxy group, each of R₆, R₇ and R₈ is a hydrogen atom, a linear or branched alkyl group which may have one or more substituents, a linear or branched and unsaturated hydrocarbon which may have one or more substituents, a substituted or unsubstituted aromatic ring, an alkoxy group, a halogen atom or a cyano group, and a combination of R₁ and R₂ or a combination of R₆ and R₇ may form a ring through a connecting group.

4. The metal-containing azo compound according to claim 1, wherein said metal is at least one member selected from the group consisting of Ni, Co, Zn and Cu.

5. A material for optical recording layer which includes the metal-containing azo compound according to claim 1.

6. An optical recording medium comprising a transparent substrate and a recording layer formed thereon and capable of permitting recording/reading-out of information by light beams, said recording layer containing the metal-containing azo compound according to claim 1.

7. The optical recording medium according to claim 6, characterized in that a reflective layer is formed on said recording layer on the side reverse to the transparent substrate.

8. The optical recording medium according to claim 6 or 7, wherein grooves having a track pitch of 0.5 to 0.9 μm are formed on said transparent substrate, and which is subjected to recording/reading-out by means of laser beams having a central wavelength of 600 to 700 nm.

9. The optical recording medium according to claim 6, wherein the thickness of said recording layer is controlled to be in a range of 100 to 300 μm.
